(19) United States
(12) Patent Application Publication
(10) Pub. No.: US 2008/0084424 A1
(43) Pub. Date: Apr. 10, 2008

(54) EARLY RETIRING INSTRUCTION MECHANISM, METHOD FOR PERFORMING THE SAME AND PIXEL PROCESSING SYSTEM THEREOF

(75) Inventor: R-ming Hsu, Jhudong Township (TW)

Correspondence Address: MADSON & AUSTIN, 15 WEST SOUTH TEMPLE, SUITE 900, SALT LAKE CITY, UT, 84101, US

(73) Assignee: Silicon Integrated Systems Corp., Hsinchu (TW)

(21) Appl. No.: 11/539,773

(22) Filed: Oct. 9, 2006

(51) Int. Cl. G06T 1/00

(52) U.S. Cl. 345/522

(57) ABSTRACT

An early retiring instruction mechanism, a method for performing the early retiring instruction mechanism and a pixel processing system employing the early retiring instruction mechanism applied to a graphic processor unit (GPU) are described. The pixel processing system comprises an early retiring instruction mechanism and a pixel shader. The early retiring instruction mechanism selectively retires a plurality of instructions in a first program in order to generate at least one early retiring instruction in a second program. The pixel shader is connected to the early retiring instruction mechanism. The pixel shader fetches the second program and decodes at least one early retiring instruction to execute the second program therein for processing a plurality of pixels. Then, the pixel shader checks whether the pixels in the process of the early retiring instruction generated from early retiring instruction mechanism are directly issued to leave the pixel shader in advance. The early retiring instruction is an explicit retiring instruction, a retiring flow-control instruction or an instruction having a retire bit.

### FIELD OF THE INVENTION

The present invention relates to a retiring mechanism, a method for performing the retiring mechanism and a pixel processing system thereof, and more particularly to an early retiring instruction mechanism, a method for performing the early retiring instruction mechanism and a pixel processing system employing the early retiring instruction mechanism applied to a graphic processor unit (GPU).

### BACKGROUND OF THE INVENTION

FIG. 1 is a block diagram of a pipeline configuration of a conventional graphic processor unit. The conventional graphic processor unit 10 mainly includes a triangle setup unit 12, a pixel processing unit 14 and a depth processing unit 16. The pixel processing unit 14 has a pixel shader 18, a texture unit 10 and a color interpolator 12 both connected to the pixel shader 18. A surface of three-dimensional (3D) object is divided into a plurality of triangles two-dimensionally arranged in terms of their neighboring relationship and having an arbitrary size. Each of the triangles has three vertices which are forwarded to the triangle setup unit 12. The triangle setup unit 12 outputs the parameters of the pixels, such as the positions of the pixels in triangles and texture coordinates of the vertices of the corresponding triangles, to the pixel processing unit 14. In the pixel processing unit 14, based on the positions of the pixels and texture coordinates of the vertices, the texture unit 10 interpolates the texture coordinates for all the pixels. The interpolated texture coordinates of the pixels are inputted and then processed in the pixel shader 18 (with DirectX terms, or Fragment Processor in OpenGL terms). Next, the pixel shader 18 executes a texture load instruction to return the processed texture coordinates to the texture unit 10. Based on the unprocessed texture coordinates and the processed texture coordinates, the texture unit 10 samples the texture colors of the pixels in a texture map and outputs the texture colors to the pixel shader 18. Meanwhile, based on the positions of the pixels and texture coordinates of the vertices, the color interpolator 12 interpolates the vertex colors for all the pixels and outputs the vertex colors of the pixels to the pixel shader 18. The pixel shader 18 then processes the texture colors and the vertex colors of the pixels and outputs color values and depth values of the pixels to the depth processing unit 16, the final pixel colors are obtained. The final pixel colors are then becoming available for drawing the whole frame.

FIG. 2 is a block diagram of a pixel shader having a Single Instruction Multiple Data (SIMD) branching architecture in a conventional graphic processor. The shader program including a plurality of instructions is inputted into an instruction queue 20. Then, the point data in the input stream will be processed according to the instructions in the instruction queue 20. The processed results of the point data are issued to generate an output stream. The sequences of point data transmitted by both the input stream and the output stream should be identical. It should be noted that the point data are defined as vertexes in a vertex shader and as pixels in a pixel shader.

The fetcher 22 reads two instructions from the instruction queue based on the program counter (PC) 24. A decoder 26 is used to decode the fetched instructions into control signals to control the pipeline operation of the arithmetic logic units (ALUs) 28. The register access port (RAP) 32 accesses the point data stored in the register 30. The point data between instructions are dependent and control signals between instructions are the same. However, there are no data dependency and control signal dependency between point data. Therefore, the number N of point data may be simultaneously processed in a time-division manner to avoid the limitation of an instruction execution cycle. That is, even if an instruction consumes one or more execution cycles termed as L, next number W of point data in next cycle, followed by a current cycle, may be implemented in a pipeline operation until the number N of point data are completely processed. Number W is defined as the processing amount of point data per ALU cycle. When the number N is greater than or equal to W*L (cycles), all the point data performed by current instruction is complete and next instruction is then performed on all the point data. Therefore, it is necessary to prepare the register amount N for storing the number W*L of point data in the pixel shader when the point data is performed by the instruction in a batch processing manner.

In FIG. 2, because the number N of point data are operated in a batch manner by the same instruction, the different instructions corresponding to different point data should be totally performed on all the point data. In other words, it is still required to perform all the instructions with respect to each point data even if one portion of instructions does not necessarily perform on another portion of point data. Then, each of the partial instructions can mask actions on the portion of point data according to the instruction condition to disable the actions on the portion of point data. Such a situation is defined as a SIMD branching method. For an example of branch instruction “if-else”, all the instructions in the branch “if-else” are required to be executed on the point data. Then, the branches conformed to the instruction condition are written into the register 30 but the branches not conformed to the condition of the instruction are disabled from the register 30. As a result, for the number N of point data, the pixel shader only includes a program counter 24, a fetcher 22 and a decoder 26. When concurrently performing the point data of number W in the ALU 28, only a control signal and a register access port are required. Therefore, all the point data are subject to the same operation path and ending instruction in the SIMD architecture.

As shown in FIG. 3, it is a block diagram of a pixel shader having a Multiple Instruction Multiple Data (MIMD) branching architecture in a conventional graphic processor. SIMD branching method is inefficient because it has to perform all the branch instructions. There is a need to perform instruction on the point data corresponding to execution paths according to different instruction conditions. Such a situation is defined as MIMD branching method. Since the condition decision result of the point data in view of different instruction conditions, instruction execution path and executed instruction thereof are varied with condition decision result of different point data. The number N of point data in a processing batch has to store each program counter corresponding to the point data. When the point data of number W are concurrently performed, the program counters of number W should be prepared for the point data. Further, the instructions of number W are fetched, decoded into different control signals and implemented in ALUs of number W.

As shown in FIG. 3, MIMD branching architecture prepares the program counters of number N and, respectively, fetchers and decoders of number W for the point data processing. The ALUs of number W can access the registers 30 of number W, respectively, via the register access ports (RAPs) 32 of number W. Furthermore, while both instruction execution path and ending instruction of each point data are different, a reorder mechanism 34 is employed to arrange the output stream sequence and input stream sequence so that the two sequences are the same order. Thus, the point data which end with an out-of-order manner in the output stream are reordered such that output stream sequence is in-order and identical to the input stream sequence. When each point is completely processed in the pixel shader, a retiring bit stored in the register is assigned to one point. After assigning the retiring bit of current point, the current point can be having an assigned retiring bit can be issued to the output stream while all the points before the current point are completely processed or issued to the output stream. As a result, the out-of-order status of the point data are recorded by the reorder mechanism 34 and the point data are issued to the output stream in a specific number per cycle.

As mentioned above, the hardware cost implementing MIMD branching architecture is considerably greater than that of SIMD branching architecture. However, in graphic application, it is necessary to provide the branch loop application with the high efficiency of MIMD branching architecture. The reason is that the branch loop employs a few instructions to process most of the simple graphic application. On the other hand, the complicated graphic effects utilize many instructions to process the effects. This is so-called early-out method in the graphic application.

FIGS. 4A and 4B are shader programs of early out branching and looping in a conventional graphic processor. In FIG. 4A, the instructions of one condition 40 in a branch are fewer than that of other condition 42. However, the execution frequency of the instruction in the condition 40 is higher than that of the condition 42. Therefore, the instruction execution speed in the condition 40 must be accelerated to increase the operation performance of the program. Unfortunately, in SIMD branching architecture, all the point data will be performed once with each instruction. Additionally, all point data should be performed by the instructions in the complicated branch, such as the instruction in the condition 42. Furthermore, extra processing time of branch instructions should be taken. For another example of program loop in FIG. 4B, the loop repeatedly executes all point data in maximum times while SIMD architecture is applied. Thus, the performance of the program is reduced.

Consequently, there is a need to develop a pixel processing system having an early retiring instruction mechanism for reducing the hardware cost and increasing performance of graphic processor unit.

### SUMMARY OF THE INVENTION

The first objective of the present invention is to provide a pixel processing system having an early retiring instruction mechanism to increase operation performance of program.

The second objective of the present invention is to provide an early retiring instruction mechanism to retire early instructions to improve hardware cost-effectiveness of the pixel processing system.

According to the above objectives, the present invention sets forth an early retiring instruction mechanism, a method for performing the early retiring instruction mechanism and a pixel processing system employing the same.

The pixel processing system comprises an early retiring instruction mechanism and a pixel shader. The early retiring instruction mechanism selectively retires a plurality of instructions in a first program in order to generate at least one early retiring instruction in a second program. The pixel shader is connected to the early retiring instruction mechanism. The pixel shader fetches the second program and decodes at least one early retiring instruction to execute the second program therein for processing a plurality of pixels. Then, the pixel shader checks whether the pixels in the process of the early retiring instruction generated from early retiring instruction mechanism are directly issued to leave the pixel shader in advance. The early retiring instruction is an explicit retiring instruction, a retiring flow-control instruction or an instruction having a retire bit (or termed as a complete bit).

The pixel shader comprises a retiring decoder 104, arithmetic logic unit (ALU) and a register access port. The retiring decoder is used to decode at least one early retiring instruction into a control signal. The arithmetic logic unit (ALU) connected to the decoder performs an arithmetic logic operation on a plurality of register components of the early retiring instruction according to the control signal. The register access port connected to the ALU selects the register components to transform operand formats of the early retiring instruction.

In one embodiment, the pixel shader further comprises instruction memory and a fetcher. The instruction memory, such as instruction queue, receives the second program and stores the instructions having at least one early retiring instruction. The fetcher connected to the instruction memory, fetching the instructions having at least one early retiring instruction stored in the instruction memory according to a program counter. The pixel shader further comprises a register unit connected to the register access port, storing data of the register components of the instructions having the early retiring instruction.

More importantly, the pixel shader further comprises a reorder mechanism 114 connected to the register unit, reordering the pixels having out-of-order retiring bits in order to form sequentially pixels having in-order retiring bits. The output sequences of the pixels are identical to the input sequences of the pixels. The reorder mechanism is preferably implemented by a plurality of AND logic gates or any type of logic gates, such as OR gate or NOT gate, combination thereof.

The early retiring instruction mechanism further comprises a flow graph generator, block ending checker and a retiring instruction modifier. The flow graph generator receives the first program and scans the instructions in the first program to generate a flow graph having a plurality of basic blocks, wherein each of the basic blocks comprises at least one instruction. The block ending checker is connected to the flow graph generator and is utilized to check out at least one terminal basic block of the basic blocks in order to identify at least one last flow-control instruction in at least one terminal basic block. The retiring instruction modifier coupled to the block ending checker modifies the last flow-control instruction into the early retiring instruction.

In one embodiment, the early retiring instruction mechanism further comprises a block duplicator connected between the flow graph and the block ending checker, duplicating the instructions in the last terminal basic block and thus increase the retiring possibility. The duplicated instructions are moved into another basic block and the last terminal basic block is cancelled. The block duplicator checks the last basic block whether the instruction amount in the last basic block is less than a threshold value. The instruction early retiring instruction mechanism further comprises a block swapper connected between the flow graph generator and block ending checker, swapping one basic block to another basic block each other. The block swapper checks the instruction amount difference between one basic block and another basic block.

In operation, a plurality of instructions in a first program is selectively retired in order to generate at least one early retiring instruction in a second program. In one embodiment, during the step of selectively retiring the instructions in the first program, the first program is inversely scanned in order to identify a last flow-control instruction of the instructions. Then, the last flow-control instruction is modified into the early retiring instruction.

In another embodiment, during the step of selectively retiring the instructions in the first program, the instructions are scanned in order to generate a flow graph having a plurality of basic blocks, wherein each of the basic blocks comprises at least one instruction. The terminal basic block of the basic blocks is checked out in order to identify the last flow-control instruction in the terminal basic block. The last flow-control instruction is modified into the early retiring instruction.

Then, the instructions having at least one early retiring instruction in the second program are fetched according to a program counter. Afterwards, the early retiring instruction is decoded into a control signal. Next, an arithmetic logic operation performs on a plurality of register components of the early retiring instruction according to the control signal. In one embodiment, before the step of checking whether the pixels in the process of the early retiring instruction is directly issued, the pixels having out-of-order retiring bits are reordered in order to form sequentially pixels having in-order retiring bits. Finally, the early checks whether the pixels in the process of the early retiring instruction is directly issued.

The advantages of the present invention include: (a) increasing operation performance of the program by the early retiring mechanism and a retiring decoder thereof; and (b) improving the hardware cost-effectiveness of the pixel processing system by the simple SIMD architecture.

### BRIEF DESCRIPTION OF THE DRAWINGS

FIG. 1 is a block diagram of a pipeline configuration of a conventional graphic processor unit.

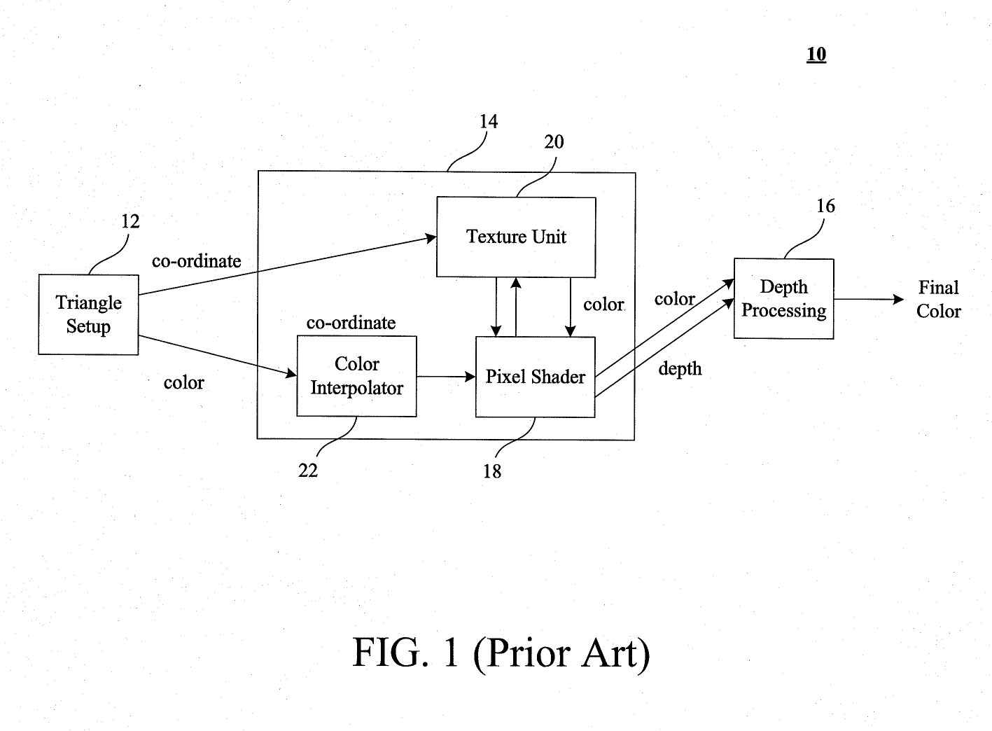

FIG. 2 is a block diagram of a pixel shader having a SIMD branching architecture in a conventional graphic processor.

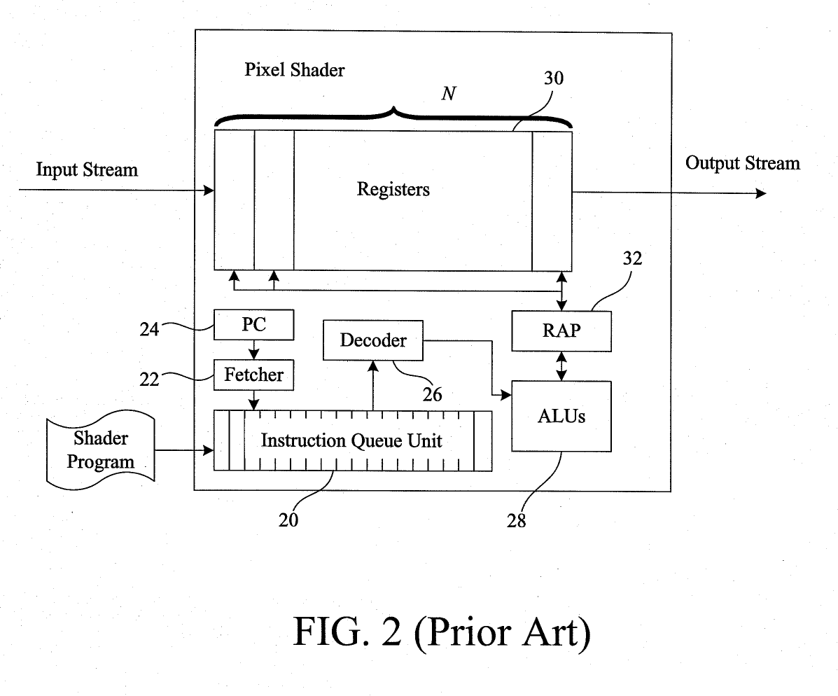

FIG. 3 is a block diagram of a pixel shader having a MIMD branching architecture in a conventional graphic processor.

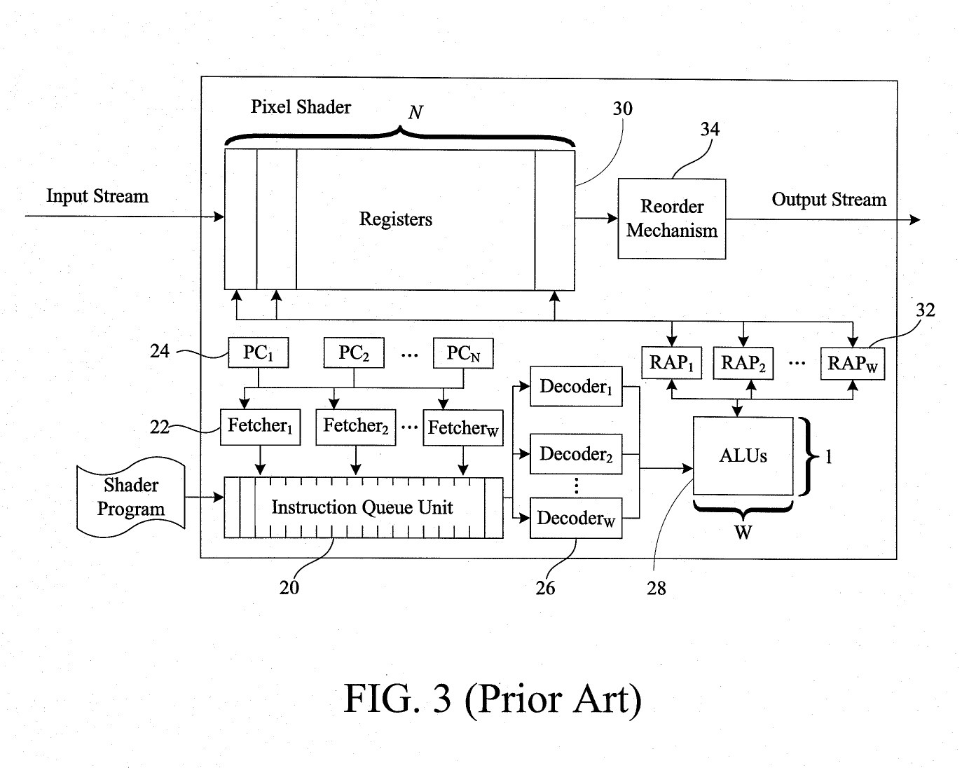

FIGS. 4A and 4B are shader programs of early out branching and looping in a conventional graphic processor.

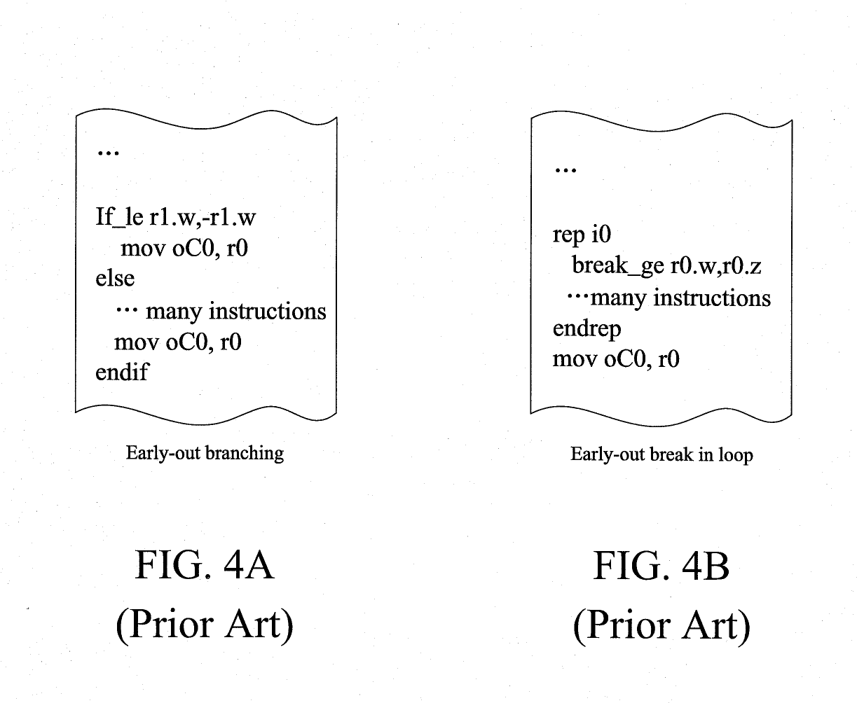

FIG. 5 is a block diagram of a pixel processing system having an early retiring instruction mechanism according to one preferred embodiment of the present invention.

FIG. 6 is an example program having the early retiring instruction mechanism in FIG. 5 according to one embodiment of the present invention.

FIG. 7 is a detailed block diagram of the reorder mechanism in FIG. 5 according to one embodiment of the present invention.

FIG. 8 is a detailed block diagram of the early retiring instruction mechanism in FIG. 5 according to a first embodiment of the present invention.

FIG. 9 is an example program performed in the early retiring instruction mechanism in FIG. 8 according to the first embodiment of the present invention.

FIG. 10 is a detailed block diagram of the early retiring instruction mechanism in FIG. 5 according to a second embodiment of the present invention.

FIG. 11 is a block diagram of a first example program applied to the early retiring instruction mechanism in FIG. 10 according to one embodiment of the present invention.

FIG. 12 is a block diagram of a second example program applied to the early retiring instruction mechanism in FIG. 10 according to one embodiment of the present invention.

FIG. 13 is a block diagram of a third example program applied to the early retiring instruction mechanism in FIG. 10 according to one embodiment of the present invention.

FIG. 14 shows a flow chart of performing a pixel processing system according to the present invention.

### DETAILED DESCRIPTION OF THE PREFERRED EMBODIMENTS

The present invention is directed to a pixel processing system having an early retiring instruction mechanism to increase operation performance of the program. Furthermore, the early retiring instruction mechanism early retires instructions to improve hardware cost-effectiveness of the pixel processing system. It should be noted that the early retiring instruction mechanism is applicable to DirectX and OpenGL standards, particularly, to vertex shader, geometric shader or the combination utilized in DirectX standard.

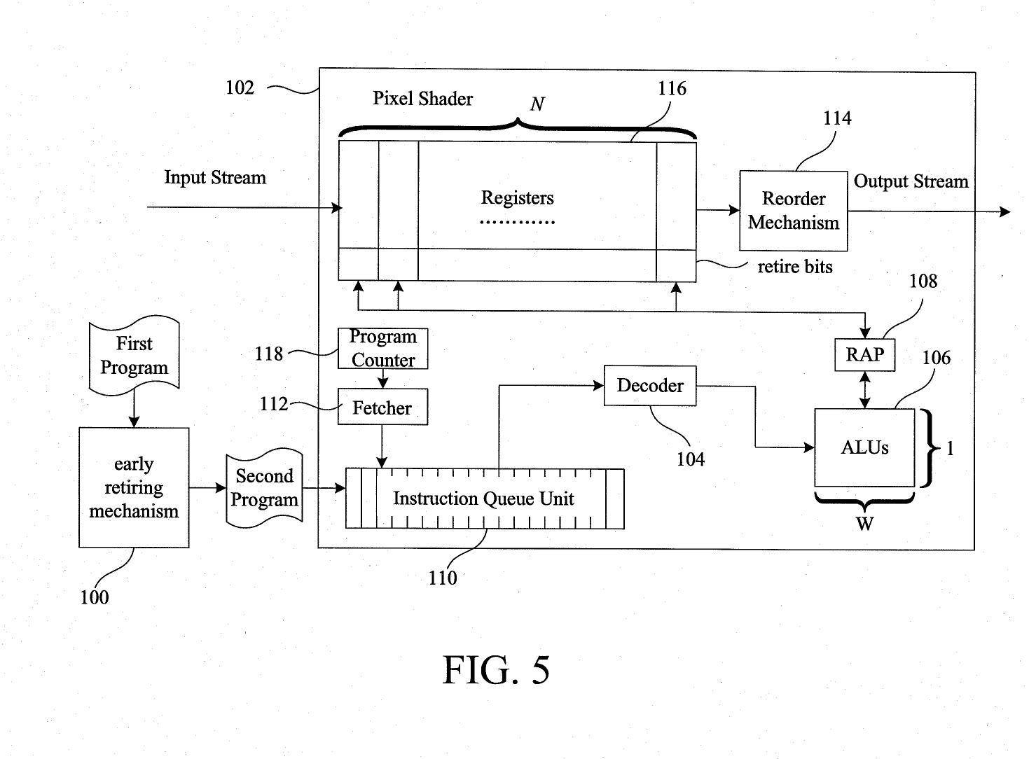

FIG. 5 is a block diagram of a pixel processing system having an early retiring instruction mechanism according to one preferred embodiment of the present invention. The pixel processing system comprises an early retiring instruction mechanism 100 and a pixel shader 102. The early retiring instruction mechanism 100 selectively retires a plurality of instructions in a first program in order to generate at least one early retiring instruction in a second program. The pixel shader 102 is connected to the instruction early retiring mechanism 100. The pixel shader 102 fetches the second program and decodes at least one early retiring instruction to execute the second program therein for processing a plurality of pixels. Then, the pixel shader 102 checks whether the pixels in the process of the early retiring instruction generated from early retiring instruction mechanism are directly issued to leave the pixel shader 102 in advance. The early retiring instruction is an explicit retiring instruction, a retiring flow-control instruction or an instruction having a retire bit (or termed as a complete bit).

The pixel shader 102 comprises a retiring decoder 104, arithmetic logic unit (ALU) 106 and a register access port 108. The retiring decoder 104 is used to decode at least one early retiring instruction into a control signal. The arithmetic logic unit (ALU) 106 connected to the retiring decoder 104 performs an arithmetic logic operation on a plurality of register components of the early retiring instruction according to the control signal. The register access port 108 connected to the ALU 106 selects the register components to transform operand formats of the early retiring instruction.

In one embodiment, the pixel shader 102 further comprises instruction memory 110 and a fetcher 112. The instruction memory 110, such as instruction queue, receives the second program and stores the instructions having at least one early retiring instruction. The fetcher is connected to the instruction memory 110 and fetches the instructions having at least one early retiring instruction stored in the instruction memory 110 according to a program counter 118. The pixel shader 102 further comprises a register unit 116 connected to the register access port 108, storing data of the register components of the instructions having the early retiring instruction.

More importantly, the pixel shader 102 further comprises a reorder mechanism 114 connected to the register unit 116, reordering the pixels having out-of-order retiring bits in order to form sequentially pixels having in-order retiring bits. The output sequences of the pixels are identical to the input sequences of the pixels. The reorder mechanism 114 is preferably implemented by a plurality of AND logic gates or any type of logic gates, such as OR gate or NOT gate.

By employing explicit retiring instructions, retiring combined instructions or instructions having explicit retiring bit, the present invention provides an instruction early retiring mechanism 100 for identifying the instruction retiring state in hardware or software manner. The retiring combined instruction, such as “if_or_retire”, “else_or_retire”, “break_or_retire”, or “call_or_retire”, is preferably a form of flow-control instruction with retiring function. A reorder mechanism 114 used in the MIMD branching is applied to the SIMD branching in order to achieve instruction early-out to improve the operation efficiency of the pixel processing system.

Considering the hardware cost-effectiveness of the pixel processing system, by the reorder mechanism 114 and the retiring decoder 104, the early retiring instruction mechanism 100 can considerably save the number N of program counters (PCs) 118, the number W of the fetchers, retiring decoders 104, or register access ports (RAPs) 108.

Furthermore, in comparison with SIMD branching architecture, the pixel processing system advantageously includes a reorder mechanism 114 and a retiring decoder 104. The reorder mechanism 114 is used to reorder the out-of-order retiring bits to form in-order retiring bits, appended to each of point data in the register, so that the output sequences of point data in the output stream are identical to the input sequences of the input stream.

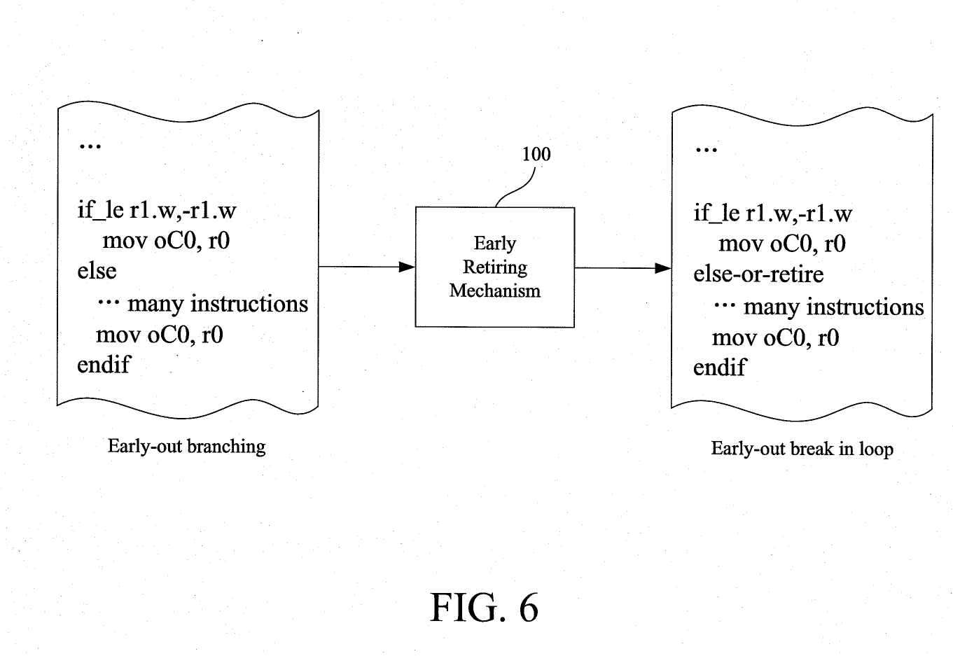

FIG. 6 is an example program having the early retiring instruction mechanism 100 in FIG. 5 according to one embodiment of the present invention. A portion of pixel shader 102 program having branching instructions is utilized in early-out graphic application, as shown in FIG. 6. The number of the instructions allocated in block “if” is less than that of the instructions allotted in block “else”. However, it is required to implement the instruction in block “if” to process most of the point data, such as pixels. In the present invention, early retiring instruction mechanism 100 rewrites the instruction “else” in block “else” into a new instruction “else_or_retire” in order to selectively set the retiring bit by checking whether the condition of new instruction “else_or_retire” is satisfied.

In the present invention, only a SIMD branching architecture is required. When each pixels passes through the instruction implementation in block “else_or_retire”, a retiring bit is assigned to the pixel if the pixel does not meet the instruction condition in block “else_or_retire” or meets the instruction condition in block “if”. Conversely, if the pixel meets the instruction condition in block “else_or_retire” or does not meet the instruction condition in block “if”, a retiring bit is assigned to the pixel after the last instruction of block “else_or_retire”is completely implemented. The retiring bit assigned to the pixel represents that the pixel meets the retiring condition and can be issued to output stream. Then, the reorder mechanism 114 reorders the retireable pixels and issues the in-order retireable pixels to the output stream while the pixels located before the retireable pixel have retired and issued to the output stream. More advantageously, the operation efficiency of pixel processing system is improved because fewer pixels are performed by block “else_or_retire” and the fewer pixels are allocated in a small region, which is so-called spatial locality.

In one embodiment, retiring flow-control instruction is depicted as follows: instruction “if_or_retire” provides condition function “if” and assigned a retiring bit to a pixel while the condition function “if” is not satisfied; instruction “else_or_retire” provides condition function “else” and assigned a retiring bit to a pixel while the condition function “if” is not satisfied; instruction “break_or_retire” provides condition function “break” and assigned a retiring bit to a pixel while the condition function “if” is not satisfied; and instruction “call_or_retire” provides condition function “else” and assigned a retiring bit to a pixel while the condition function “call” is not satisfied.

It should be noted that early retiring instruction mechanism 100 can be implemented in a form of software, hardware, or the combination thereof. While implemented in a software manner, the early retiring instruction mechanism 100 may be a software tool kit running in an operating system (OS), a program loader or a part of a device driver attached to a latter part of a compiler. Furthermore, while implemented in a hardware manner, the early retiring instruction mechanism 100 is preferably connected to an instruction fetching unit or a decoder. That is, the early retiring instruction mechanism 100 is located in front of the instruction queue unit and decoder of the pixel shader 102 in the preferred embodiment. In another embodiment, the early retiring instruction mechanism 100 may be built within a graphic processing unit.

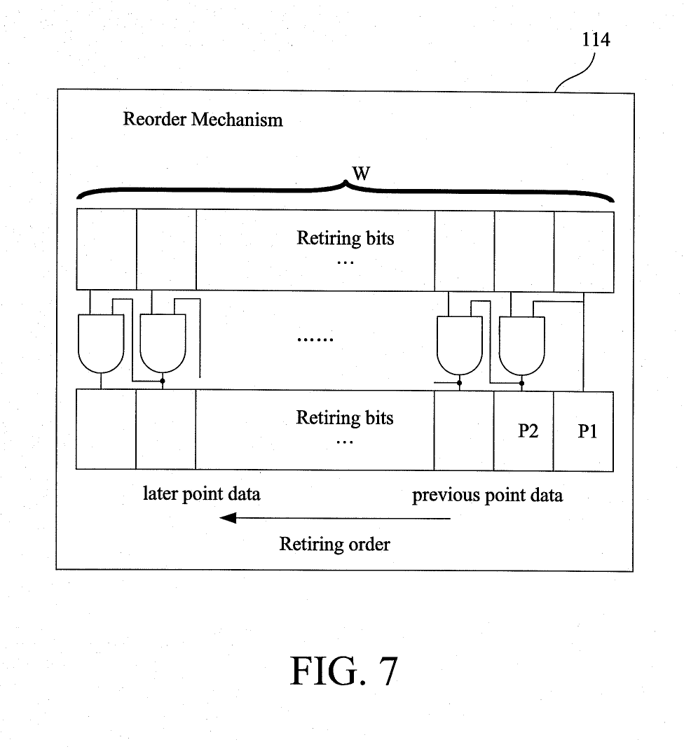

As shown in FIG. 7, it is a detailed block diagram of the reorder mechanism 114 in FIG. 5 according to one embodiment of the present invention. Point data number W per cycle, preferably matching with the shader bandwidth, are sequentially issued to the output stream and leave the pixel shader 102 according to the input order of the point data entering the input stream. The retiring bits in the register correspond to each of the point data, respectively. When the pixel processing system prepares to retire a current point, it is necessary to set the retire bit of the current point and the retire bits of the previous points before the current point. Thus, the current point retires according to the retired previous points. When retiring pixel 2 (P2), the retire bit of pixel 2 (P2) is set and the retire bit of the pixel 1 (P1) before pixel 2 (P2) is set in advance. In one embodiment, the reorder mechanism 114 first checks one retiring bit corresponding to one pixel until all the retiring bits W have been completely checked bit-by-bit. The reorder mechanism 114 can be implemented by a plurality of AND logic gates where one AND gate includes two inputs and one output. The reorder mechanism 114 can be implemented by any type of logic gates, such as OR gate or NOT gate.

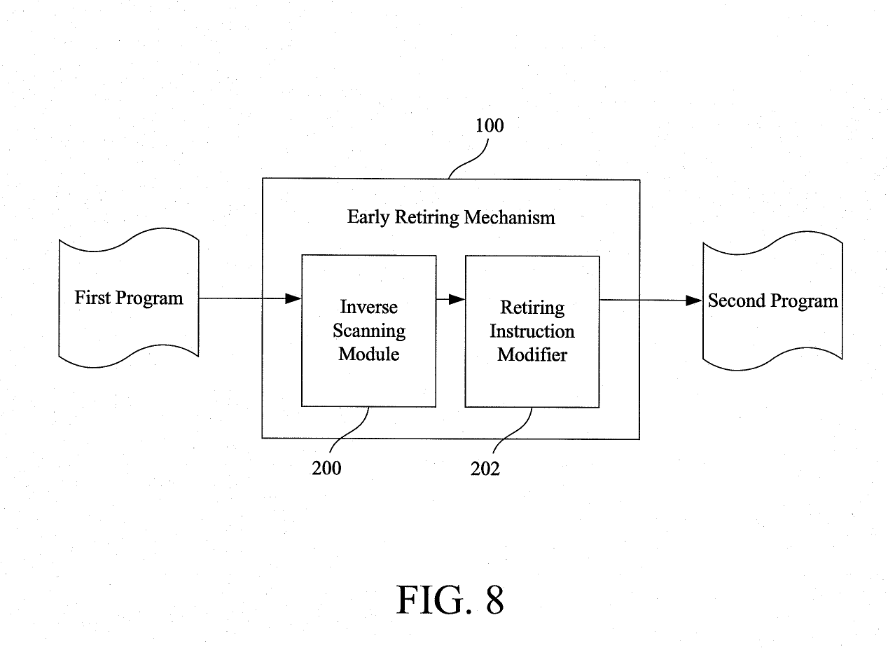

FIG. 8 is a detailed block diagram of the early retiring instruction mechanism 100 in FIG. 5 according to a first embodiment of the present invention. The early retiring instruction mechanism 100 comprises inverse scanning module 200 and retiring instruction modifier 202. The inverse scanning module 200 inversely scans the first program in order to identify a last flow-control instruction of the instructions. The retiring instruction modifier 202 coupled to the inverse scanning module 200 modifies the last flow-control instruction into the early retiring instruction.

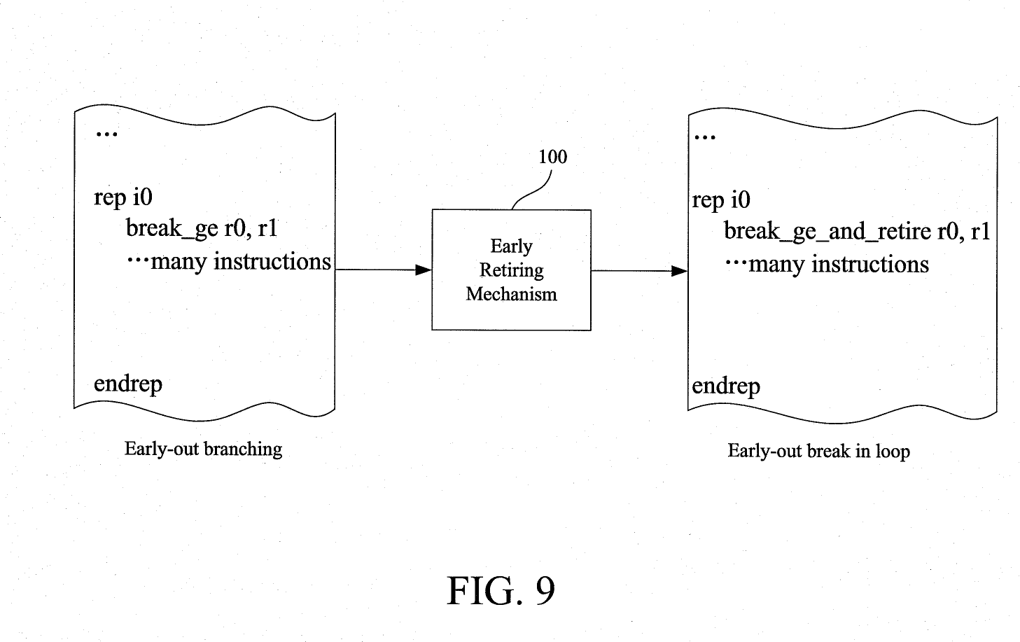

FIG. 9 is an example program performed in the early retiring instruction mechanism 100 in FIG. 8 according to the first embodiment of the present invention. The inverse scanning module 200 inversely scans the first program from end to beginning of the first program to identify the terminal flow-control instruction, such as flow-control instructions “if”, “else”, “break”, and “call”. Preferably, the flow-control instruction “call” comprises conditional instruction “call”. Then, retiring instruction modifier 202 modifies the terminal instruction into an early retiring instruction, such as “ifor_retire”, “else_or_retire”, “break_or_retire” and “call_or_retire”, to designate the retiring information on the program to generate the second program, as shown in FIG. 6. In FIG. 9, it is an example program having looping. The early retiring mechanism 100 identifies the flow-control instruction “break_ge” and modifies it into the early retiring instruction “break_ge_and_retire”.

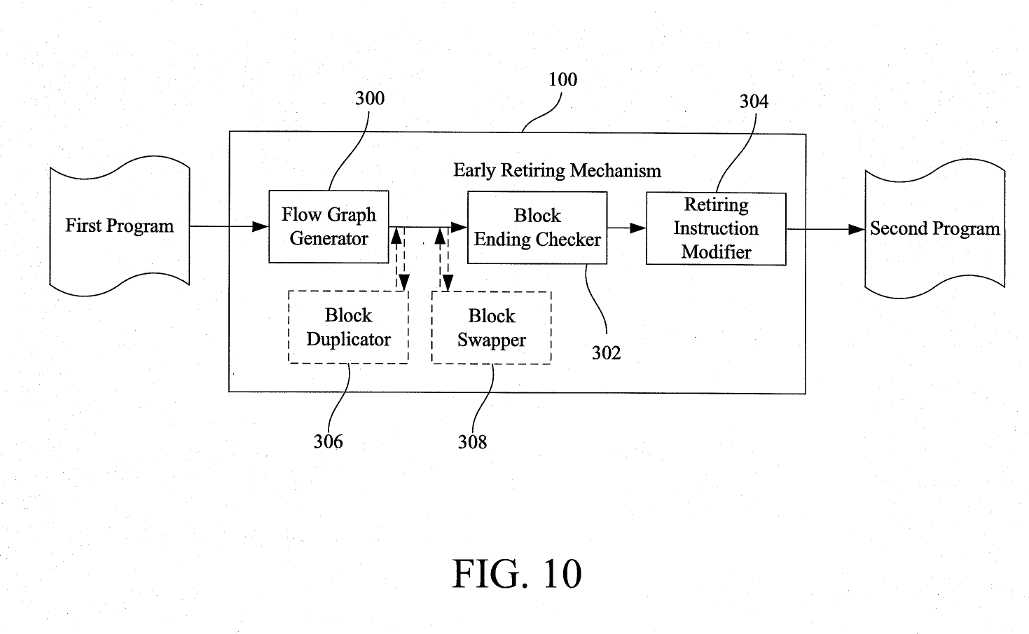

FIG. 10 is a detailed block diagram of the early retiring instruction mechanism 100 in FIG. 5 according to a second embodiment of the present invention. The early retiring instruction mechanism 100 further comprises a flow graph generator 300, block ending checker 302 and a retiring instruction modifier 304. The flow graph generator 300 receives the first program and scans the instructions in the first program to generate a flow graph having a plurality of basic blocks, wherein each of the basic blocks comprises at least one instruction. The block ending checker 302 is connected to the flow graph generator 300 and is utilized to check out at least one terminal basic block of the basic blocks in order to identify at least one last flow-control instruction in at least one terminal basic block. The retiring instruction modifier 304 coupled to the block ending checker 302 modifies the last flow-control instruction into the early retiring instruction.

In one embodiment, the early retiring instruction mechanism 100 further comprises a block duplicator 306 connected between the flow graph generator 300 and the block ending checker 302, duplicating the instructions in the last terminal basic block and thus increase the retiring possibility. The duplicated instructions are moved into another basic block and the last terminal basic block is cancelled. The block duplicator 306 checks the last basic block whether the instruction amount in the last basic block is less than a threshold value. The early retiring instruction mechanism 100 further comprises a block swapper 308 connected between the flow graph generator 300 and block ending checker 302. The block swapper 308 is able to swap one basic block to another basic block each other. The block swapper 308 checks the instruction amount difference between one basic block and another basic block.

The first program is divided into a plurality of basic ending blocks according the flow-control instructions of the first program. The instructions in one basic ending block are or not implemented together. Therefore, the flow-control instructions end one basic block and generate a starting basic block while jumping to one basic block. As such, a first program is divided into a plurality of basic blocks and the flow-control instruction is directed to the basic block using a directional edge to generate a flow chart of the basic blocks therebetween. When the flow-control instruction may jump to the end of the first program, the directional edge is directed to the null.

After the flow chart of the basic blocks are constructed, the basic block ending checker 302 scans the flow chart to check the basic blocks which the first program ends. If yes, the last instruction in the ending basic block is identified as the retiring instruction. Then, the retiring instruction modifier 304 scans the first program again. Meanwhile, if the identified retiring instruction is “if”, “else”, “else”, conditional “call” instruction, the early retiring instruction mechanism 100 is utilized to modify the instruction. Consequentially, the nested flow control loop is crossed in order to find more retiring situation.

In the present invention, new flow-control instructions having retiring function are used to identify the early retiring situation. In one embodiment, if an explicit retiring instruction is used to identify the early retiring, the retiring instruction modifier 304 directly appendixes the retiring instruction to the instruction which are identified as retire. In another embodiment, if using a retiring bit, the retiring instruction modifier 304 modifies the retiring bit of the instruction identified as retire.

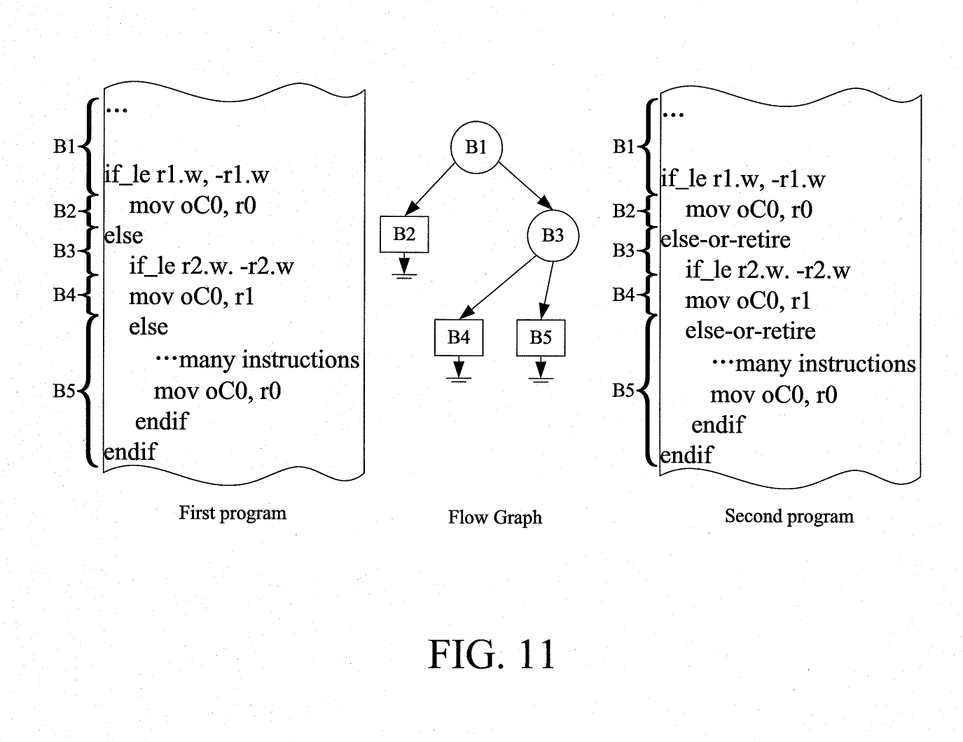

FIG. 11 is a diagram of a first example program applied to the flow-control analysis in the nested branch using the early retiring instruction mechanism 100 in FIG. 10 according to one embodiment of the present invention. The flow graph generator 300 scans the first program to construct the flow graph. The square basic block represents the ending blocks (B2, B4 and B5) of the first program. Then, the block ending checker 302 scans the flow graph to check the ending blocks (B2, B4, and B5) and identifies the last instruction in the ending blocks as retiring instructions. Afterwards, the retiring instruction modifier 304 scans the first program and modifies the next sequential instructions, i.e. “else” instructions as “else_or_retire” instruction so as to create a second program. Preferably, the last instruction in the block “B5” has the property of native retiring function and it is unnecessary to be identified.

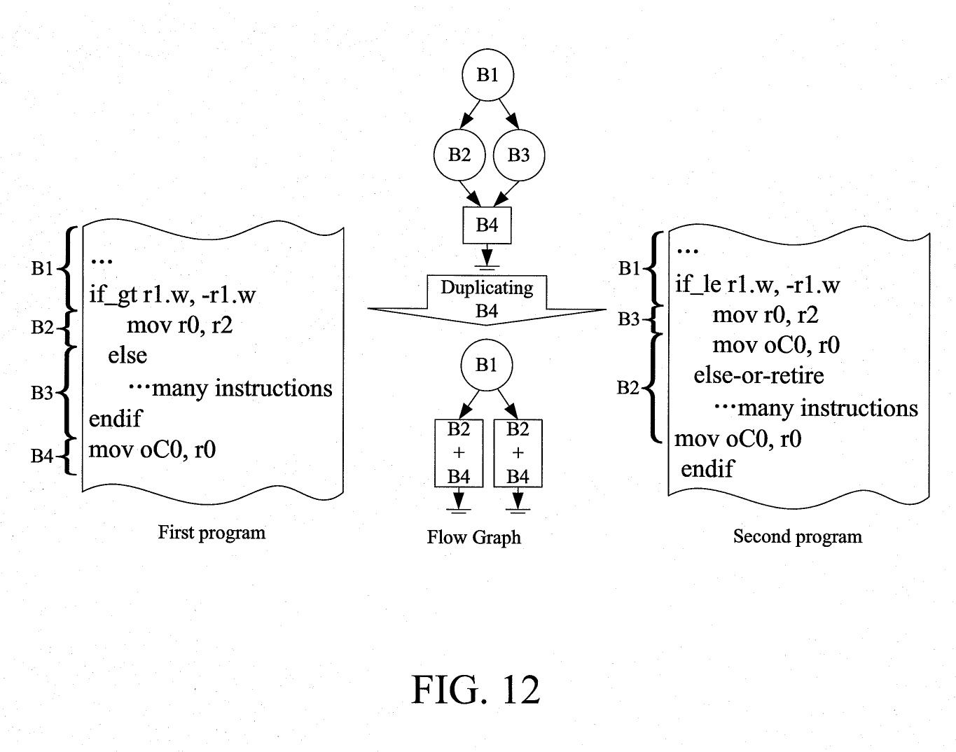

FIG. 12 is a block diagram of a second example program applied to the instruction early retiring mechanism 100 in FIG. 10 according to one embodiment of the present invention. After constructing the flow graph, the block duplicator 306 scans the flow graph in order to check the ending block of the program. When the instruction amount is less than a threshold value, such as from one to three instructions, the block duplicator 306 duplicates the blocks into the end of the source block and merges the blocks. Then, the source blocks are grounded. Thus, the source blocks become the ending blocks so as to increase the retiring possibility. In one embodiment, by comparing the instruction amount of a block with a threshold value, if the instruction amount is greater than the threshold value, the duplication operation is performed by the block duplicator 306. In another embodiment, by comparing the instruction amount difference between the blocks, the block duplicator 306 is actuated when the instruction amount difference is greater than a threshold value. Therefore, the retiring possibility of the instruction in the program is increased. In FIG. 12, the first program is divided into five blocks, B1, B2, B3, and B4. The block duplicator 306 duplicates the block B4 to merge block B4 to blocks B2 and B3 in order to increase the retiring possibility. Further, block B4 is then cancelled.

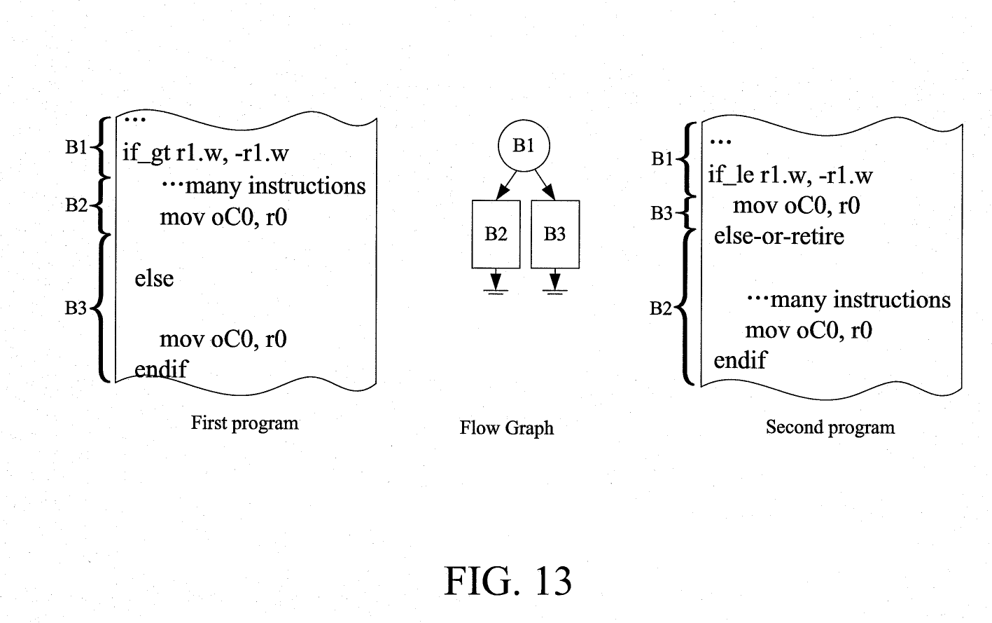

FIG. 13 is a block diagram of a third example program applied to the instruction early retiring mechanism 100 in FIG. 10 according to one embodiment of the present invention. After constructing the flow graph, the block swapper 308 scans the flow graph and checks the instruction amount of blocks “if” and “else” in the branch. When the instruction amount of block “if” is greater than that of block “else”, blocks “if” and “else” are swapped and the branch condition thereof are inversely changed, such as branch condition “if_gt” is inversely changed into “if_le”. Thus, the block having greater instruction amount is located in the end of the program such that the retiring possibility is increased.

Furthermore, when utilizing a GPU to process the collision between object collisions, the early retiring mechanism is particularly suitable for the physical collision case. Generally speaking, the collision probability prediction having the maximum time-consuming operations is divided into two stages, including broad phase and narrow phase. During the broad phase, the pixel processing system checks the object collision probability. Then, during the narrow phase, after the objects having collision probability are identified, each of identified object pairs is precisely calculated to generate collision data of the identified objects. According to the result of the broad phase, an instruction branch in the second program is able to perform early out process and bypasses the objects without collision probability which is identified in the broad phase. Thus, the instruction branch compactly processes the objects with collision probability which is identified in the narrow phase.

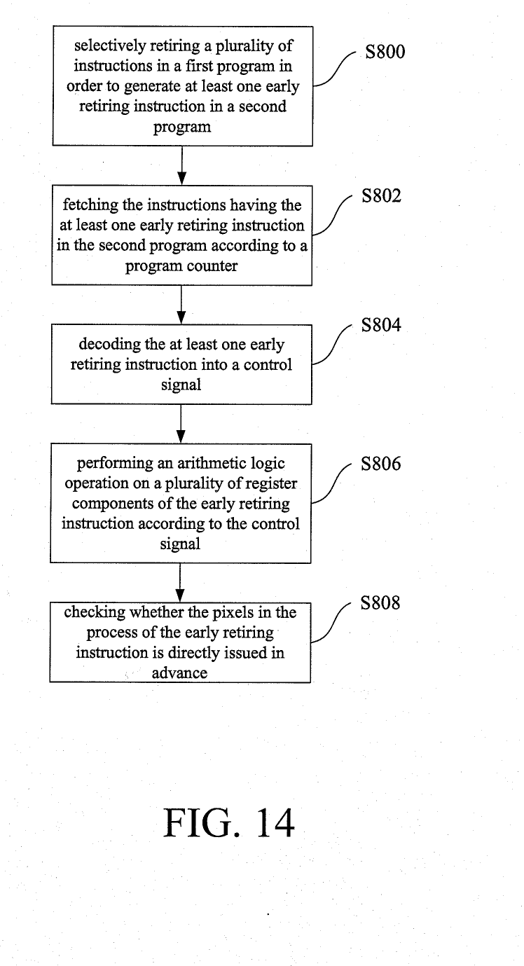

FIG. 14 shows a flow chart of performing a pixel processing system according to the present invention. Starting at step S800, a plurality of instructions in a first program is selectively retired in order to generate at least one early retiring instruction in a second program. In one embodiment, during the step of selectively retiring the instructions in the first program, the first program is inversely scanned in order to identify a last flow-control instruction of the instructions. Then, the last flow-control instruction is modified into the early retiring instruction.

In another embodiment, during the step of selectively retiring the instructions in the first program, the instructions are scanned in order to generate a flow graph having a plurality of basic blocks, wherein each of the basic blocks comprises at least one instruction. The terminal basic block of the basic blocks is checked out in order to identify the last flow-control instruction in the terminal basic block. The last flow-control instruction is modified into the early retiring instruction.

After scanning the instructions, the instructions in the last terminal basic block are duplicated. Then, the duplicated instructions are moved into another basic block and the last terminal basic block is cancelled. The early retiring mechanism checks the last basic block whether the instruction amount in the last basic block is less than a threshold value. Further, the block swapper 308 swaps one basic block to another basic block each other. During the step of swapping one basic block, the instruction amount difference between one basic block and another basic block is checked.

In step S802, the instructions having at least one early retiring instruction in the second program are fetched according to a program counter. In step S804, the early retiring instruction is decoded into a control signal. In step S806, an arithmetic logic operation performs on a plurality of register components of the early retiring instruction according to the control signal. In one embodiment, before the step of checking whether the pixels in the process of the early retiring instruction is directly issued, the pixels having out-of-order retiring bits are reordered in order to form sequentially pixels having in-order retiring bits. In step S808, the early checks whether the pixels in the process of the early retiring instruction is directly issued.

The advantages of the present invention include: (a) increasing operation performance of the program by the early retiring mechanism and a retiring decoder thereof; and (b) improving the hardware cost-effectiveness of the pixel processing system by the simple SIMD architecture.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structures.

What is claimed is:

1. A pixel processing system, comprising:
an early retiring instruction mechanism, selectively retiring a plurality of instructions in a first program in order to generate at least one early retiring instruction in a second program; and
a pixel shader connected to the early retiring instruction mechanism, fetching the second program and decoding at least one early retiring instruction to execute the second program therein for processing a plurality of pixels, wherein the pixel shader checks whether the pixels in the process of the early retiring instruction generated from early retiring instruction mechanism are directly issued to leave the pixel shader in advance.

2. The pixel processing system of claim 1, wherein the early retiring instruction mechanism further comprises:
an inverse scanning module, inversely scanning the first program in order to identify a last flow-control instruction of the instructions; and
a retiring instruction modifier coupled to the inverse scanning module, modifying the last flow-control instruction into the early retiring instruction.

3. The pixel processing system of claim 1, wherein the early retiring instruction mechanism further comprises:
a flow graph generator, receiving the first program and scanning the instructions therein in order to generate a flow graph having a plurality of basic blocks, wherein each of the basic blocks comprises at least one instruction;
a block ending checker connected to the flow graph generator, checking out at least one terminal basic block of the basic blocks in order to identify at least one last flow-control instruction in at least one terminal basic block; and
a retiring instruction modifier coupled to the block ending checker, modifying the last flow-control instruction into the early retiring instruction.

4. The pixel processing system of claim 3, wherein the early retiring instruction mechanism further comprises a block duplicator connected between the flow graph and the block ending checker, duplicating the instructions in the last terminal basic block.

5. The pixel processing system of claim 4, wherein the duplicated instructions are moved into another basic block and the last terminal basic block is cancelled.

6. The pixel processing system of claim 4, wherein the block duplicator checks at least one last basic block whether the instruction amount in the last basic block is less than a threshold value.

7. The pixel processing system of claim 3, wherein the instruction early retiring instruction mechanism further comprises a block swapper connected between the flow graph generator and block ending checker, swapping one basic block to another basic block each other.

8. The pixel processing system of claim 7, wherein the block swapper checks the instruction amount difference between one basic block and another basic block.

9. The pixel processing system of claim 1, wherein the early retiring instruction is one selecting from a group consisting of an explicit retiring instruction, a retiring flow-control instruction and an instruction having a retire bit.

10. The pixel processing system of claim 1, wherein the pixel shader comprises:
a retiring decoder, decoding at least one early retiring instruction into a control signal;
an arithmetic logic unit (ALU) connected to the decoder, performing an arithmetic logic operation on a plurality of register components of the early retiring instruction according to the control signal; and
a register access port connected to the ALU, selecting the register components to transform operand formats of the early retiring instruction.

11. The pixel processing system of claim 10, wherein the pixel shader further comprises:
an instruction memory, receiving the second program and storing the instructions having the at least one early retiring instruction; and
a fetcher connected to the instruction memory, fetching the instructions having the at least one early retiring instruction stored in the instruction memory according to a program counter.

12. The pixel processing system of claim 10, wherein the pixel shader further comprises a register unit connected to the register access port, storing data of the register components of the instructions having the early retiring instruction.

13. The pixel processing system of claim 10, wherein the pixel shader further comprises a reorder mechanism connected to the register unit, reordering the pixels having out-of-order retiring bits in order to form sequentially pixels having in-order retiring bits.

14. The pixel processing system of claim 13, wherein the output sequences of the pixels are identical to the input sequences of the pixels.

15. The pixel processing system of claim 13, wherein the reorder mechanism is implemented by a plurality of AND logic gates.

16. A method of retiring at least one instruction to processing the pixels in a pixel processing system, the method comprising the steps of:
selectively retiring a plurality of instructions in a first program in order to generate at least one early retiring instruction in a second program;
fetching the instructions having the at least one early retiring instruction in the second program according to a program counter;
decoding the at least one early retiring instruction into a control signal;
performing an arithmetic logic operation on a plurality of register components of the early retiring instruction according to the control signal; and
checking whether the pixels in the process of the early retiring instruction is directly issued in advance.

17. The method of claim 16, during the step of selectively retiring the instructions in the first program, further comprising the steps of:
inversely scanning the first program in order to identify a last flow-control instruction of the instructions; and
modifying the last flow-control instruction into the early retiring instruction.

18. The method of claim 16, during the step of selectively retiring the instructions in the first program, further comprising the steps of:
scanning the instructions in order to generate a flow graph having a plurality of basic blocks, wherein each of the basic blocks comprises at least one instruction;
checking out at least one terminal basic block of the basic blocks in order to identify at least one last flow-control instruction in the at least one terminal basic block; and
modifying the last flow-control instruction into the early retiring instruction.

19. The method of claim 18, after scanning the instructions, further comprising duplicating the instructions in the last terminal basic block.

20. The method of claim 19, after duplicating the instructions, further comprising the steps of:
moving the duplicated instructions into another basic block; and
cancelling the last terminal basic block.

21. The method of claim 19, further comprising checking the at least one last basic block whether the instruction amount in the last basic block is less than a threshold value.

22. The method of claim 18, after the step of scanning the instructions, further comprising swapping one basic block to another basic block each other.

23. The method of claim 22, during the step of swapping one basic block, further comprising checking the instruction amount difference between one basic block and another basic block.

24. The method of claim 16, wherein the early retiring instruction is one selecting from a group consisting of an explicit retiring instruction, a retiring flow-control instruction and an instruction having a retire bit.

25. The method of claim 16, before the step of checking whether the pixels in the process of the early retiring instruction is directly issued, further comprising reordering the pixels having out-of-order retiring bits in order to form sequentially pixels having in-order retiring bits.

26. The method of claim 25, wherein the output sequences of the pixels are identical to the input sequences of the pixels.
